(19) United States
(12) Patent Application Publication
(10) Pub. No.: US 2024/0046730 A1
(43) Pub. Date: Feb. 8, 2024

(54) SYSTEMS AND METHODS FOR POLITICAL GOVERNANCE THAT COMBINE REPRESENTATIVE AND DIRECT DEMOCRACY USING DECENTRALIZED OR CENTRALIZED BLOCKCHAIN TECHNOLOGY

(71) Applicant: Larry O'BRIEN, Ottawa (CA)

(72) Inventor: Larry O'BRIEN, Ottawa (CA)

(21) Appl. No.: 18/227,133

(22) Filed: Jul. 27, 2023

Related U.S. Application Data
(60) Provisional application No. 63/395,524, filed on Aug. 5, 2022.

(51) Int. Cl. G07C 13/00; H04L 9/00

(52) U.S. Cl. CPC G07C 13/00; H04L 9/50

(57) ABSTRACT

The systems and methods of a governance process that combines conventional election of representatives with an ongoing direct democracy governance system. This combination includes electing one or more elected representatives, identifying an issue, elected representatives voting on the issue, sending the voting results of the elected representatives to one or more voters. voting by the one or more voters for one or more elected representatives, the one or more voters use the issue and the voting results of the elected representatives. Voting results of the one or more voters for each of the one or more elected representatives are calculated. This calculation being the determination of proportional electoral support of the one or more voters who voted for each elected representative. A second result on the issue is implemented using the proportional electoral support of each elected representative.

### CROSS-REFERENCE TO RELATED APPLICATIONS

The application claims the benefit of priority to U.S. Provisional Patent Application U.S. patent application Ser. No. 63/395,524 entitled “Systems and Methods for Political Governance that Combine Representative and Direct Democracy using Decentralized or Centralized Blockchain Technology” filed Aug. 5, 2022.

### FIELD

The disclosure relates generally to governance and more specifically to systems and methods for combining traditional representative democracy with direct democracy.

### BACKGROUND

Citizens have lost confidence in the traditional representative governance model. Citizens have become distrustful of their elected officials and the processes available to citizens to elect governments. A contributor to this reduced trust is a governance system that provides citizens with no recourse to penalize elected officials who fail to vote in the way they promised, or reward elected officials who vote in line with citizens' wishes.

Contributors to this lack of trust include a lack of access to an elected representative's voting records, lobbyist meetings, and voting attendance. This lack of access has led citizens to believe that elected representatives are influenced more by special influence groups and lobbyists than by the citizens who elected them.

Plebiscite and referendum decision-making are also not practical for deciding issues at the city, state, provincial and county levels because these types of decision-making are cumbersome, expensive and slow to implement.

Some electronic voting systems currently in use automate selecting an elected representative. Unfortunately, these methods serve only to centralize current governance systems.

Representative democracy is suffering from a deficit of confidence from the people. An observer can almost feel the frustration in the electorate growing more intense every election cycle. The election night is always full of voter fraud and corruption accusations, which are troublesome to the voter. Moreover, after an election, the representative is immediately influenced by well-funded lobby groups and special interest groups. It does not take long before the agenda is affected by lobbying, and that fact is souring the credibility of democracy.

Younger voters, in particular, do not believe our democracy is working the way it should. They do not vote at the same rate as boomers, who hold their nose and vote, likely out of habit. Younger people resist voting not because they do not understand democracy and freedom but because they understand how it works and it does not satisfy their need to be heard. The increase in cynicism is due to frustration that their “voice” is not being heard. Therefore, solutions must increase the “voice” of all voters and, most importantly, the younger voters in our society.

As a result, there is a need for an improved governance system that obviates or mitigates one of more limitations of the prior art.

This background information is provided for the purpose of making known information believed by the applicant to be of possible relevance to the present invention. No admission is necessarily intended, nor should be construed, that any of the preceding information constitutes prior art against the present invention.

### SUMMARY

It is an object of the present invention to obviate disadvantages of the prior art and apply new methodologies that take advantage of new technologies that include blockchain, smart contracts, voting tokens, artificial intelligence and secure digital identification.

An embodiment of this disclosure can be to present a new form of governance that can combine elements of traditional elected representation with direct democracy. This approach is to elect one or more elected representatives, identify an issue, the elected representatives vote on the issue, send the voting results of the elected representatives to one or more voters and voting by the one or more voters for one or more elected representatives. The one or more voters use the issue and the voting results of the elected representatives to determine which of the one or more elected representatives to vote for. This approach also calculates voting results of the one or more voters for each of the one or more elected representatives. The calculation is the determination of proportional electoral support of the one or more voters who voted for each elected representative. The approach also implements a second result on the issue using the proportional electoral support of each elected representative.

Embodiments have been described above in conjunction with aspects of the present disclosure upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also applicable to other aspects, as will be apparent to those skilled in the art.

### BRIEF DESCRIPTION OF FIGS.

Embodiments of the invention will now be described, by way of example only, by reference to the attached figures, wherein:

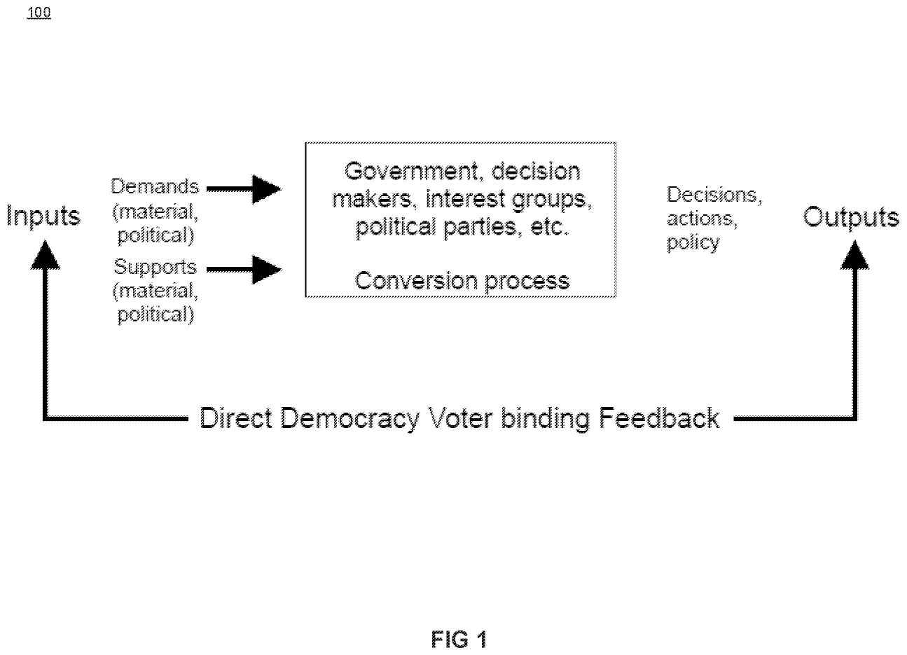

FIG. 1 illustrates a merger of direct democracy feedback by the voters in a representative voting system.

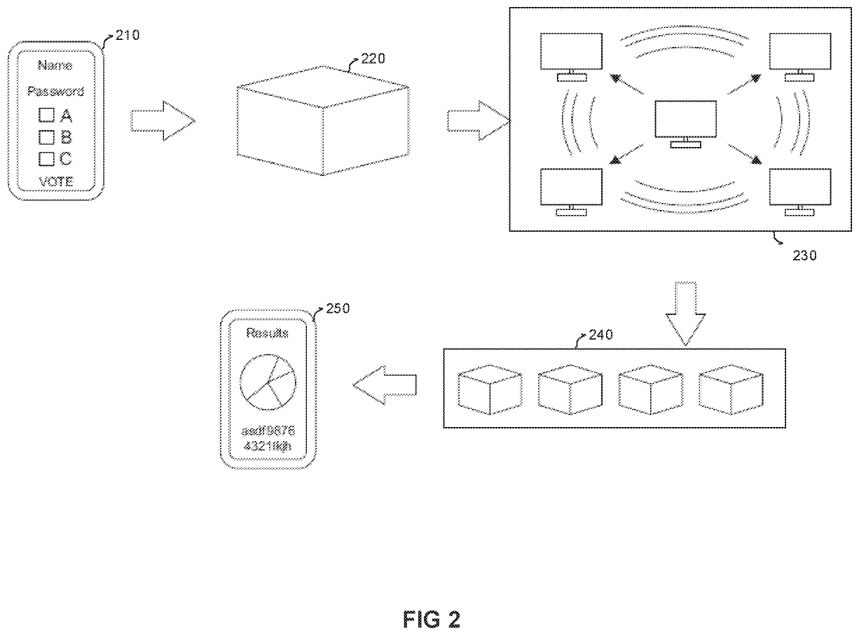

FIG. 2 illustrates a smart phone voting system that is configured to allow citizens to vote on specific issues that have been debated by elected representatives and vetted by professional non-partisan administrative support staff.

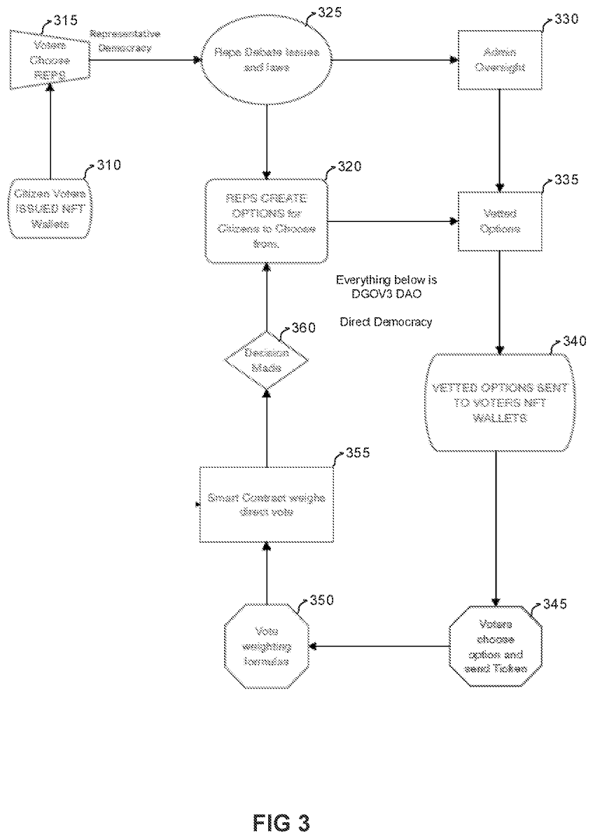

FIG. 3 illustrates how representative and direct democracy are combined using smart contracts, a DAO, and voting tokens.

It will be noted that throughout the appended drawings, like features are identified by like reference numerals.

### DETAILED DESCRIPTION

Embodiments of this disclosure describe a model that can be used to elect representatives and to also provide ongoing participation in the decision-making process through rules based and/or mathematical algorithms.

In some embodiments, the model used to elect representatives is known to those skilled in the art as the proportional representation system. The characteristics of the proportional representation system are that seats in the legislature are allocated in proportion to votes with the hope that assemblies and governments will accurately reflect the preferences of the electorate.

In some embodiments, the model used to elect representatives is known as the ranked ballot system. The ranked ballot system, also known by those skilled in the art as the preferential voting system or the ranked choice voting system, is related to any voting system where voters use a rank to order candidates or options in a sequence from first, second, third and onwards on the voter's ballots.

In some embodiments, the model used to elect representatives is known as the first past the post system. The first past the post system is an electoral system where voters cast a vote for a single candidate and the candidate with the most votes wins the election.

These models can be implemented using a distributed or centralized autonomous organization (“DAO”) based on block chains that can use smart contracts and voting tokens. Smart contracts can be used to determine the process used to determine voting outcomes.

In some embodiments, a democratic system can be built that is not subject to being interpreted by humans, making it a pure rules-based governance system. These systems can be based on DAOs, and these systems can rely on voting tokens and smart contracts.

As discussed herein, in some embodiments a DAO is an emerging form of a legal structure. With no central governing body, every member within a DAO typically shares a common goal and attempts to act in the best interest of the DAO. Popularized through cryptocurrency enthusiasts and blockchain technology, DAOs can be used to make decisions in a bottoms-up management approach.

In some embodiments, DAOs can include other organizations and structures such as partnerships, corporations, collections of individuals, unincorporated clubs, group of people who do not have standing and the like.

In some embodiments, a DAO can have similar requirements for governance as other communities.

Embodiments of this disclosure, as illustrated by FIG. 1, can include voting methods, procedures and systems that can be used to combine representative democracy and direct democracy in a manner that can enable the electorate to have influence with regard to specific issues while maintaining the efficiencies of representative democracy 100. This combination can be permissionless as it may not require human intervention. This combination can be combined into contemporary democratic voting and governance systems.

These voting methods, procedures and systems can be implemented using any combination of hardware and/or software and/or a specialized blockchain and citizen voting token, smart contract and/or a DAO.

These embodiments can include methodologies that can take advantage of new technologies that also can include any combination of blockchain, smart contracts, artificial intelligence (AI) and secure digital identification. These methodologies can also combine these new technologies with a proportional vote weighting system. This system can allow citizens to support an elected representative who is different from the representative they originally voted for in an election.

Another aspect of these methodologies can allow citizens, using a citizen voting token, to support a representative that has views and a position that most accurately reflect the that of the citizen.

The citizen voting token can be a voting token that an individual citizen can use to support the position of a specific representative for a specific issue.

This support can be reflected in the weight of the representative's voting power in relation to the voting power of other representatives voting on the same issue. As a non-limiting example of this weight, a representative that has 30% of the citizen support will also have a 30% voting block when all representatives vote.

These methodologies can further include systems, software and methods that can be used to proportionally alter the weight of the representative's voting power in council based on the support of the representative by citizens.

The methodologies can also include procedures and methods that can automatically calculate the outcome of any kind of vote by a legislative body based on support each council member has from the citizens.

The methodologies can allow for different types of calculations to be used under a variety of conditions.

In some embodiments this vote can be binding on the government.

In some embodiments this vote can be advisory to the elected representatives.

In some embodiments the voting tokens can be fungible or non-fungible.

These methodologies can also include methods, systems and procedures that can identify which issues can be subject to influence by a direct democracy vote through the issue of voting tokens to the citizens.

Representatives can be elected by any variety of systems that can include casting ballots, postal voting, and electronic voting wherein each system can use a variety of formulas to determine the successful representative. These methods can include a first past the post, plurality voting and any other methods that can be used as needed.

In some embodiments the representatives choose certain issues that will be subject direct democracy using a DAO, smart contracts, and voting tokens combined with a representative voting system as illustrated by FIG. 2.

In some embodiments voters can be issued wallets that can maintain and store citizen voting tokens and enable the citizen to participate in the direct vote on certain issues, procedures and policies.

Issues can be identified that can require additional input from the electorate. This process and information can be stored in a DAO or a publicly funded, special purpose blockchain.

The positions of the representatives can be published electronically to the electorate using a citizen voter application 210. Publishing this way can ensure that only citizens qualified using bio-metrics and/or two-factor authentication (2FA) can access the resulting voting process.

The citizens of the electorate can then vote for the representative that has a position that is closest to the position of the citizen. The citizen can use the issue the elected representative voted on as well as the voting results of the elected representatives to determine the position of the elected representatives, and decide if the position of the elected representative on the issue is close to their position on the issue. To vote in this manner, citizens can be required to use a voting token to enable their vote to be included in the tabulation of votes used to determine the percentage of the electorate that supports the positions of the representatives. This calculation of percentage of the electorate that supports the positions of the representatives can also be referred to as the proportional electoral support of each elected representative. This tabulation can also be published.

Smart phones and/or public voting terminals can be used by the electorate to vote. These same smart phones and/or public voting terminals can also be used to record the results of the electorate's votes.

A smart contract can tally the weighted support for direct issue related voting, also known to those skilled in the art as a second result on the issue, as well as if the motion or bill is approved, has failed or has been amended. In some embodiments, the smart contact can use the proportional electoral support of each elected representative to determine the second result on the issue.

Smart contracts can be programmable self-executing contracts written in code in the blockchain. As a non-limiting example, they can be the tools that a new class of software developer can use to build complex applications on Ethereum and similar networks. Also as a non-limiting example, the smart contract can analyze the weighted support for a direct issue and determine that the position held by one of the representatives is approved when this representative receives 75% of the direct vote support. This analysis can use any combination of many different methods where the particular method or methods used can be determined based on the type of government and the issue up for vote.

The results of the direct issue voting can be published and referenced to the representatives and the government administration.

Also, a sentiment analysis can be performed to ensure that these results are in line with voter objectives. This sentiment analysis can be performed using any number of AI tools that have the ability to scan social media or simple polling pushed to the electorate.

These methodologies can be in the form of a voter voting system that can be available for use by all levels of government and can be based on a citizen block chain that can be specifically designed to be distributed and funded by all levels of government.

Some embodiments can include a voting token in the form of a voting token that can be sent to each registered voter citizen wallet wherein each registered voter citizen wallet can have a unique identification on the blockchain.

l Some embodiments can provide one or more positions of representatives that are stored within the voting token to one or more citizens.

In some embodiments, a citizen that has been validated to vote can choose the position that they are in favour of by sending or using the voting token in the DAO.

In some embodiments, sentiment can be considered using AI algorithms to analyze voting records of elected officials and to enable transparency.

In some embodiments governance can refer to how a government, either local or regional, and stakeholders decide how to plan, finance and manage the governance of a community or government.

Some embodiments enable governance to include a process of negotiation and contestation over the allocation of social and material resources and political power.

In some embodiments, a method to provide verification of the identity of citizens can be implemented using a variety of technical methods and can include but are not limited to biometrics.

In some embodiments, sentiment analysis, or opinion mining, can be a natural language processing (“NLP”) technique that can be used to determine whether data is positive, negative or neutral with regards to an issue. Sentiment analysis can often be performed on textual data.

In some embodiments, a sunshine law can be a law requiring a government agency to open its official meetings and records to the general public.

In some embodiments, citizen engagement can be methods or processes that can increase the participation of citizens in the governance process.

Some non-limiting examples can include new technologies that when integrated into a novel and unique process can secure the democratic process for liberal democracies.

In some embodiments, smart contracts, AI and new technologies can provide an opportunity to invent a new form of governance that can solve the problem related to voters not believing they have a voice in the on-going process of governance. Novel democratic methodologies can enhance governance for cities, states, provinces and federal governments.

A DAO 220 is an organization constructed by rules encoded as a computer program. This program is often transparent and controlled by the organization's members only. It is not controlled by a centralized government. As a result, a DAO is member owned and not influenced by a centralized leadership. A DOA's voting transaction records and program rules can be maintained on a blockchain 230. In some embodiments these transaction records and program rules can be stored immutably 240. In some embodiments, the transaction records can include voting result 250 by the elected representatives, the calculated voting results of the voters and the second result on the issue.

In some embodiments, DAOs can be organizations created using blockchain technology and smart contracts. Smart Contracts can be embedded in the DAO and used to determine all governance processes that can be used in accordance with the applicable legislation.

In some embodiments AI algorithms can be used to monitor voter sentiment on all issues related to the operation of the government organization and can provide methods, and data to enable voters to overturn or challenge decisions made on their behalf by elected representatives.

In some embodiments, smart contracts imbedded in a DAO can use defined rules and procedures regarding the operation of a government or community. The smart contract can reflect the existing legislation that can define the activities of a specific form of government.

In some embodiments, a secure form of digital ID can be used as a key to allow citizens to access electronic data stored on the DAO and to enable secure communications.

In some embodiments, a DAO's smart contracts can be coupled with new processes and procedures that can increase transparency and also increase the efficiency of governance at any level of government.

In some embodiments, a political management system can provide clear governance and transparency with novel methodologies employing DAOs, smart contracts, and related technology.

In some embodiments, smart contracts can define responsibilities and authorization for spending and management of the elected officials.

In some embodiments, a method can be used to store voting information and transfer that information securely and secretly to a voting aggregator and also subsequently communicate results to citizens and the government.

In some embodiments, methods and systems can be used to manage multiple smart contracts to serve unique geographical territories and levels of societal governance. This can include community, municipal, state, provincial or federal levels of the governance process.

In some embodiments, voting and direct communication with political and staff can be conducted using a citizen's digital ID to open a secure communications channel.

In some embodiments, only citizens in good standing are allowed to cast a vote for elected representatives and direct democracy issues.

In some embodiments an AI based algorithm can provide a summary of the voting record of each incumbent representative and compare their voting record with previous positions they have taken. An AI algorithm can review the stated election promises of a new representative so one or more voters can compare the positions of each representative running for that position.

Embodiments of this disclosure address societal governance that can provide safety and security to citizens. This governance can be provided using a novel system and/or method for effective management of birth certificates using a combination of DAOs. These DAOs can use smart contracts to define a citizen's rights to medical services and voting registration based on a voting token assigned at birth.

Some embodiments can include communication protocols and blockchain specifications that can provide a transparent and trusted history of every representative's vote.

Some embodiments can include a birth certificate process that can include the assignment of a voting token to record biological information that can include deoxyribonucleic acid (“DNA”), blood type, an any other medical information that can be collected at birth and used for voter ID verification.

Some embodiments can include a birth process for assigning an AI based medical support algorithm from a health DAO. In some algorithms, this algorithm can become a primary health caregiver which can used by a citizen until their death. In some embodiments, this algorithm can include the integration of communication protocols and the like that can be used to provide AI-based medical care.

Some embodiments can include using an assigned voting token to enable voting rights.

Some embodiments can include a trustless method and system that can allow one or more certain citizen voting tokens to unlock one or more voting privileges secretly and securely.

Some embodiments can also include a method that can be used to store voting information and transfer this voting information securely and secretly to one or more voting aggregators.

Some embodiments can also communicate voting results to allow citizens who have had their voting information securely and secretly transferred.

Some embodiments can also integrate a citizen's voting token into the tax collection process of municipalities, states, provinces, and federal government.

Some embodiments can provide that an election can be performed periodically based on constitutional requirements. Some non-limiting examples of constitutions are constitutions that require an election be held once every two years and other constitutions that require an election be held every four years.

Some embodiments can include that an elected government can determine processes for running an election in a geographic area and in a jurisdiction in which they have authority.

Some embodiments can include that elected representatives each have a voting weight. When elected representatives vote, they can vote either for a proposal or against a proposal.

The voting weight of all elected representatives who voted for a proposal can be summed and the voting weight of all elected representatives who voted against a proposal can also be summed. The proposal can be adopted if the sum of voting weight for the proposal exceeds the sum of voting weight against the proposal.

In some embodiments the proposal can be rejected if the sum of the voting weight rejecting the proposal exceeds the sum of the voting weight for the proposal.

In some embodiments, the voting rights of citizens can be determined by direct democracy through the issuance of a unique token to each voter that enables that voter to cast a vote in support of the position held by a representative.

In some embodiments, the identification of legally authorized votes from voting citizens can be based on the choices made in each voting area through a variety of processes.

In some embodiments, citizens may be required to adhere to the terms and conditions of a voting agreement.

In some embodiments, voting can be a secret process.

Some embodiments can also only allow each citizen a single vote that the citizen can use to specify the position that most closely reflects the position of the voter.

In some embodiments that position will be attached to the names of a specific elected representative. As a non-limiting example if four representatives support a defined position then their names will be attached to that position.

As a non-limiting example, in a city of one million people, an administrative support staff of 15,000 can provide services like fire, police, parks and recreation, water and sewer, and over fifty services to the citizens. This city can elect ten representatives to manage the affairs of the state and make the rules and laws. Most of these representatives' work can be to ensure the administrative support staff is doing a good job. The second part of their responsibilities can be to create the laws that govern the city. A new law can be debated and can be significant enough to reach out to citizens for their input. The new law can intend to revoke the civil rights of citizens who are demonstrating against forcing citizens to get the fifth booster vaccine against a new virus spreading though the community. In this non-limiting example, the city can convert from an administrative democracy to a DAO system that can combine representative democracy with a form of direct democracy. After the representatives have debated and researched the issue in-depth, they can conclude that two positions were reasonable to take. Position one, supported by six representatives, can be to agree with the law and move forward with the mandate. Position two can be that each citizen can choose and the remaining four representatives support this position. The city administrative support staff can review both positions and send this information out to the citizens' voting token wallet along with issue voted on and the representatives' summary of the two positions. In a standard representative democracy the six representatives would win a formal vote fully supported by the pharmaceutical lobbyist. However, this may not happen. The DOA smart contract can send a voting token to every community member's wallet so that voters can determine which vetted option the voters want. When the results come back, in this non-limiting example, 74% of the voters support the second position and therefore, the vote for the four representatives wins and the law is defeated. Sentiment analysis can be used to double-check the results and the smart contracts in the DOA can then send the results to the public, the representatives and the citizens. In this non-limiting example, the elected representatives did the leg work of vetting the two best possible positions that would work and they outlined their reasoning in short memos for voters to read. The city administration can provide any budget or manpower impacts of each option. The voters spoke and the decision can be made, not to force the mandate. In this non-limiting example, a new version of constitutional democracy won the day. The feedback described herein can be binding and embedded in a smart contract as illustrated by FIG. 5 flowchart.

FIG. 1 illustrates a direct democracy feedback loop into a representational democratic block. This direct democracy voting process can require its own “checks and balances”. As a non-limiting example, prior to sending a voting token to the voters the options need to be vetted by non-partisan administrative support staff and the costing of manpower implications can be estimated and be part of the information package distributed by tokens to voters. FIG. 2 illustrates a block diagram for creating a combined representative and direct voting process.

### Tokenized Direct Voting

A tokenized direct voting process that can determine accurately the support each policy, procedure or law has from the citizens.

In embodiments this can all be done securely and secretly using blockchain tools and smart phones and can be critical to implement a DAO which can be a merged direct and representative voting system.

Another factor that can be important can be the relationship between the weight of representative votes and citizen's votes.

### Voting Weighting

In some embodiments there can be numerous mathematical formulas and many ways of weighing the votes to enable a practical relationship between direct and representative governance. In a non-limiting example, if 100% of the voters who elected the representatives vote then it can be the position with the most votes that is chosen. Also, if one million voters vote on three options then the option with the most votes can be chosen as the winner by the smart contract.

Also, if only 500,000 citizens of the total available electorate use citizen voting token to vote, the other 500,000 potential votes can be distributed equally among, as a non-limiting example, ten representatives.

As a non-limiting example of weighing 1,000,000 votes when some people do not use direct voting and 500,000 voters did not vote, the 1,000,000 votes can be distributed equally amongst ten representatives.

In this non-limiting example, each representative can have 50,000 votes related to their position. As a result, voting position one (four representatives) have 200,000 votes, voting position two (four representatives) have 200,000 votes, and voting position three (two representatives) have 100,000 votes. In this non-limiting example, smart tokenized direct votes can be allocated to the representatives as per a simple adding process. A result can be that 75% of the direct votes can be distributed between representatives 9 and 10 for a total of 375,000 (75% of 500,000) and position three can have a weighted value total of 475,000 votes.

Therefore, the winner can be position three. This is illustrated in Table 1.

TABLE 1
Non-Limiting Example Voting Formula

| The final tally | Distributed | Allocated | Total |
|---|---|---|---|
| would be: | Votes | Votes | Votes |
| Position 1 | 200,000 | 62,500 | 262,500 |
| Position 2 | 200,000 | 62,500 | 262,500 |
| Position 3 | 100,000 | 375,000 | 475,000 |
| Total Votes | 500,000 | 500,000 | 1,000,000 |

Table 1 illustrates a non-limiting example of a voting formula. Weighting formulas can be established in the DAO and can be agreed in advance of establishing the DAO.

In some embodiments information security threats will be from quantum computing-based hacking and intrusion methods. These threats will require novel methods of securing data in the post-quantum cryptographic environment, including a) Data-Centric Security (DCS) and Symmetric Key Frame Encryption (SKFE), and b) Multivariate Polynomial Public Key (MPPK) methods that work well with smartphones due to smaller digital signature sizes.

In some embodiments a candidate for becoming a representative can submit a general platform prior to being elected by the voters. This general platform can be maintained on a distributed blockchain.

In some embodiments the representatives choose certain issues that will be subject direct democracy using a DAO as illustrated by FIG. 2.

In some embodiments of this disclosure, the DAO can reside on a decentralized or centralized blockchain designed for political governance use.

Some embodiments of this disclosure can reside on one or more commercial decentralized blockchains.

Some embodiments of this disclosure can reside on one or more centralized blockchain sponsored by one or more agencies or government organizations.

In some embodiments voting tokens can be created that can be transmitted to the voter's wallet that can enable them to vote on specific issues.

In some embodiments issues that can be identified as needing additional electorate voter input can be identified as part of the constitutional requirements of a state or city.

In some embodiments the entire DAO voting process can be contained in smart contracts and are not subject to human intervention or oversight.

In some embodiments the representatives can debate the various options with input from professional administrative support staff.

In some embodiments certain items can be chosen for direct democracy input from the voters due to the choice of the representatives.

In some embodiments the items chosen to be voted on by tokens can be decided as part of the constitution of the government or community.

In some embodiments the decision of the voters can be binding.

In some embodiments the decision of the voters can be for adversary purposes to the elected representatives.

In some embodiments the administration can vet various options and provide feedback related to budget implications for review by the voters.

In some embodiments it can take approval of both the non-political administration and a majority of representatives to approve issuance of a voting token provided to the voters.

In some embodiments the representatives can form groups to support positions they believe will be best for the voters.

In some embodiments the various positions can be pushed electronically via a voting token to the citizen voter wallet and bio metrics and 2FA can be used to ensure that only the voter can use the application to vote.

In some embodiments there can be more than two competing positions from the representatives.

In some embodiments the voting options chosen by the representatives can be posted on the website of the government organization.

In some embodiments the voter ID can be a variety of biometric or personal information used for voter identification/voter ID confirmation and this voter ID can be included in the citizen wallet of the voter.

In some embodiments the system can use a variety of biometrics to confirm voter identities.

In some embodiments the citizen can vote for the representative whose position is closest the position of the citizen voter.

In some embodiments smart phones or public voting terminals can be used to cast a vote and record the results of the voting.

In some embodiments a smart contract can tally the weighted support of the direct issue related voting and if the motion or bill is approved, failed or amended.

In some embodiments the state can design its own vote weighting mechanism as part of the construction of the DAO.

In some embodiments when 100% of the voters who elected the representatives vote then it can be the position with the most votes that is chosen. If one million people vote on three options, then the option with the most votes can be chosen by the smart contract as the winner.

In some embodiments with 1,000,000 citizens, if 50% of a total available electorate use citizen ID voting token to vote, the other 500,000 potential votes can be distributed equally among the ten representatives.

In some embodiments, as a non-limiting example, if only 500,000 citizens, or 50% of a total available electorate use citizen ID voting token to vote, the other 500,000 potential votes can be distributed equally among the ten representatives. In this embodiment, the final tally can be:

| | |
|---|---|
| Position One | 262,500 votes |
| Position Two. | 262,500 votes |
| Position Three. | 475,000 votes |
| Total votes. | 1,000,000 votes |

In some embodiments results can be published and positions confirmed. The results can be pushed to the voters directly using their smart phones that hold the citizens' voter wallet.

In some embodiments a method to establish criteria to determine when direct democracy is invoked can be determined as part of the implementation process.

In some embodiments there can be a method to assign a unique wallet to each voter (310) to allow the voter to receive and view various options provided to them to review the voting results of elected representatives.

In some embodiments there can be a method to create a smart contract that will calculate the support each position from the citizens.

In some embodiments there can be a process that provides for independent vetting of a law, procedure or policy from professional administrative support staff (335) prior to the direct democracy voting.

In some embodiments the voting weight of the each of the one or more elected representatives can be re-evaluated after an election and on an issue-by-issue basis.

In some embodiments when the government sends a voting token to a citizen's wallet, the voting token can expire if it has not been used by a specific time.

In some embodiments the voting tokens can be non-transferable and can only be held in a particular voter's wallet.

In some embodiments when or if the voting token is transferred anywhere other than the DAO, the token can cease to be usable. A person skilled in the art will understand that the token has been burned.

In some embodiments there can be a smart contract voting calculation (350) that that will account for unused votes and have them divided among the representatives.

In some embodiments there can be a voting calculation in a smart contract that can determine the winning option based on a combination of representative and direct voting calculations. Non-limiting examples of contract calculations can include:

NP=EV−DV (equation 1)

DR=NP/N (equation 2)

TVR=DV+DR (equation 3)

RVS=ΣTVR (equation 4)

WIN=ΣRVS (equation 5)

### Terms

### Calculated Non-Participants in Direct Voting (NP)

# Eligible Voters (EV)
# of Participants in Direct Voting (DV)

### Calculated Distributed Votes Per Rep (DR) Total number of Representatives (N)

# of direct votes per Representative (DV)

### Total Votes Per Representative (TVR)

### Representative Vote Summary Per Position (RVS)

### Total Votes Per Position (Win)

In some embodiments polling can be done to confirm the voting process and provide state management with confirmation.

In some embodiments smart contracts can be created that can execute the tallied results and provide instructions directly to the administration.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method of governance, the method comprising:
electing one or more elected representatives;
identifying an issue;
voting on the issue by the elected representatives;
sending the voting results of the elected representatives to one or more voters;
voting by the one or more voters for one or more elected representatives, the one or more voters use the following information to determine which of the one or more elected representatives to vote for:
the issue; and
the voting results of the elected representatives;
calculating voting results of the one or more voters for each of the one or more elected representatives, the calculation being the determination of proportional electoral support of the one or more voters who voted for each elected representative; and
implementing a second result on the issue using the proportional electoral support of each elected representative.

2. The method of claim 1 wherein voting on the issue by the elected representatives further comprises summarizing the voting results of the elected representatives before sending the voting results of the elected representatives to one or more voters.

3. The method of claim 2 wherein identifying the issue that requires voting of the one or more voters is performed using a constitution of a governance organization.

4. The method of claim 2 wherein summarizing the voting results of the elected representatives is performed by an administrative support staff.

5. The method of claim 2 wherein the summary of the issues sent to the one or more voters is sent to the voting token wallet of the one or more voters.

6. The method of claim 5 wherein the voting token is stored by a distributed autonomous organization (DAO).

7. The method of claim 6 wherein the DAO embeds one or more smart contracts.

8. The method of claim 6 wherein the issue and the voting result by the elected representatives and the calculated voting results of the one or more voters and the second result on the issue are stored on a blockchain.

9. The method of claim 2 wherein the issue and the voting result by the elected representatives and the calculated voting results of the one ore more voters and the second result on the issue are stored immutably.

10. The method of claim 2 further comprising verifying the calculated voting results of the one or more voters for each of the one or more elected representatives is performed using sentiment analysis.

11. The method of claim 10 wherein sentiment analysis is performed using an artificial intelligence (AI) algorithm.

12. The method of claim 11 wherein the AI algorithm provides data that is used to overturn the second result of the one or more voters.
